(19) United States
(12) Patent Application Publication
(10) Pub. No.: US 2025/0233350 A1
(43) Pub. Date: Jul. 17, 2025

(54) CONNECTOR

(71) Applicant: YAZAKI CORPORATION, Tokyo (JP)

(72) Inventors: Kimihiro Abe, Makinohara-shi (JP); Motonori Miyanari, Susono-shi (JP); Takuya Otake, Makinohara-shi (JP)

(21) Appl. No.: 18/981,272

(22) Filed: Dec. 13, 2024

(30) Foreign Application Priority Data
Jan. 15, 2024 (JP) 2024-004143

(51) Int. Cl. H01R 13/52

(52) U.S. Cl. CPC H01R 13/5205

(57) ABSTRACT

A connector includes: a housing having a terminal accommodating chamber therein; an electric wire drawn out to an outside through an opening connected to the terminal accommodating chamber; a water stop component disposed to close a gap between an inner surface of the opening and an outer surface of the electric wire; and a cover attached to the housing on an outer side of the water stop component. The cover includes: a restriction portion disposed to face the water stop component and configured to restrict displacement of the water stop component to the outer side; a through hole provided in the restriction portion and through which the electric wire is inserted; and a slit extending in a predetermined direction from a hole edge of the through hole and communicating with the outside of a peripheral edge of the restriction portion.

### CROSS-REFERENCE TO RELATED APPLICATION(S)

This application is based upon and claims the benefit of priority from prior Japanese patent application No. 2024-004143 filed on Jan. 15, 2024, the entire contents of which are incorporated herein by reference.

### BACKGROUND

### 1. Field of the Invention

The present disclosure relates to a connector including a housing that can be fitted to a counterpart component, an electric wire that is pulled out to the outside through an opening connected to a terminal accommodating chamber of the housing, a water stop component that is disposed to close a gap between an inner surface of the opening and an outer surface of the electric wire, and a cover that is attached to the housing on an outer side of the water stop component.

### 2. Description of the Related Art

In the related art, a connector has been proposed that has a function of detecting, by using a fitting assurance component (CPA), whether a housing of the connector is in a fitting position where the housing is supposed to be fitted to a counterpart component as designed, and the connector and the counterpart component are properly fitted (hereinafter also referred to as “fitted state”) (see, for example, JP2016-213080A).

The fitting assurance component is generally used in a housing having a lock arm capable of switching between maintaining and releasing the fitted state described above. Specifically, the lock arm and the fitting assurance component are configured such that interference between the fitting assurance component and the lock arm is avoided only in a state where the housing is at the fitting position (that is, the fitted state described above), and the fitting assurance component is attached to a predetermined target attachment position. In other words, when the connector and the counterpart component are not in the fitted state, the fitting assurance component interferes with the lock arm and is not attached to the target attachment position. That is, it is possible to detect whether the connector and the counterpart component are in the fitted state based on whether the fitting assurance component can be attached to such a target attachment position.

In a connector in the related art, generally, in order to prevent water from entering a terminal accommodating chamber from the outside of the connector, a tubular rubber plug that surrounds an electric wire is attached to the electric wire, and when a terminal is accommodated in the terminal accommodating chamber, a gap between an opening of the terminal accommodating chamber and the electric wire is closed with the rubber plug. However, when the connector is mounted on a vehicle or the like and is actually used, the rubber plug may be deformed due to displacement of the electric wire depending on a direction and magnitude of an external force applied to the electric wire. Therefore, a gap may occur between the rubber plug and the opening of the terminal accommodating chamber or between the rubber plug and the electric wire, which may impair the waterproofing property of the rubber plug.

### SUMMARY

The present disclosure has been made in view of the above circumstances, and an object thereof is to provide a connector that can prevent displacement of an electric wire.

In order to achieve the above object, a connector according to the present disclosure is characterized by the following.

According to an aspect of the present disclosure, there is provided a connector including: a housing having a terminal accommodating chamber therein; an electric wire drawn out to an outside through an opening connected to the terminal accommodating chamber of the housing; a water stop component disposed to close a gap between an inner surface of the opening and an outer surface of the electric wire; and a cover attached to the housing on an outer side of the water stop component, in which the cover includes: a restriction portion disposed to face the water stop component and configured to restrict displacement of the water stop component to the outer side; a through hole provided in the restriction portion and through which the electric wire is inserted; and a slit extending in a predetermined direction from a hole edge of the through hole and communicating with the outside of a peripheral edge of the restriction portion, and in which when the cover is attached to the housing, a width of the slit is smaller than a diameter of the electric wire.

According to the connector of the present disclosure, the cover attached to the housing is provided with the slit through which the electric wire passes when attaching the cover to the electric wire and the through hole through which the electric wire attached through the slit is inserted. Further, when the cover is attached to the housing, the width of the slit is smaller than the diameter of the electric wire. Accordingly, even if an external force is applied to the electric wire in any direction intersecting the axial direction of the electric wire in a state where the cover is attached to the housing, the displacement of the electric wire is prevented by the hole wall of the through hole. In particular, even when the electric wire tries to move in a direction in which the electric wire enters the slit, the width of the slit is smaller than the diameter of the electric wire, so that the electric wire does not enter the slit. Therefore, the connector of the present configuration can prevent displacement of the electric wire.

The present disclosure is briefly described above. Further, details of the present disclosure will be further clarified by reading modes for carrying out the invention described below with reference to the accompanying drawings.

### BRIEF DESCRIPTION OF DRAWINGS

The present disclosure will become more fully understood from the detailed description given hereinbelow and the accompanying drawing which is given by way of illustration only, and thus is not limitative of the present disclosure and wherein:

FIG. 1 is a perspective view showing a connector according to an embodiment of the present disclosure and a counterpart connector.

FIG. 2 is an exploded perspective view of the connector shown in FIG. 1.

FIG. 3 is a perspective view of a female housing and a cover shown in FIG. 2 viewed from a rear side.

FIG. 4 is a rear view of the cover shown in FIG. 2.

FIG. 5 is a perspective view of the connector shown in FIG. 1 as viewed from the rear side.

FIG. 6 is a cross-sectional view taken along a line B-B in FIG. 5.

FIG. 7 is a cross-sectional view corresponding to a cross section taken along a line A-A of FIG. 1, showing a state in which the connector and the counterpart connector are in an unfitted state and the fitting assurance component (CPA) is in an initial position.

FIG. 8 is a cross-sectional view corresponding to the cross section taken along the line A-A of FIG. 1, showing a state in which the connector and the counterpart connector are in a fitted state and the fitting assurance component (CPA) is in a target attachment position.

### DETAILED DESCRIPTION OF THE INVENTION

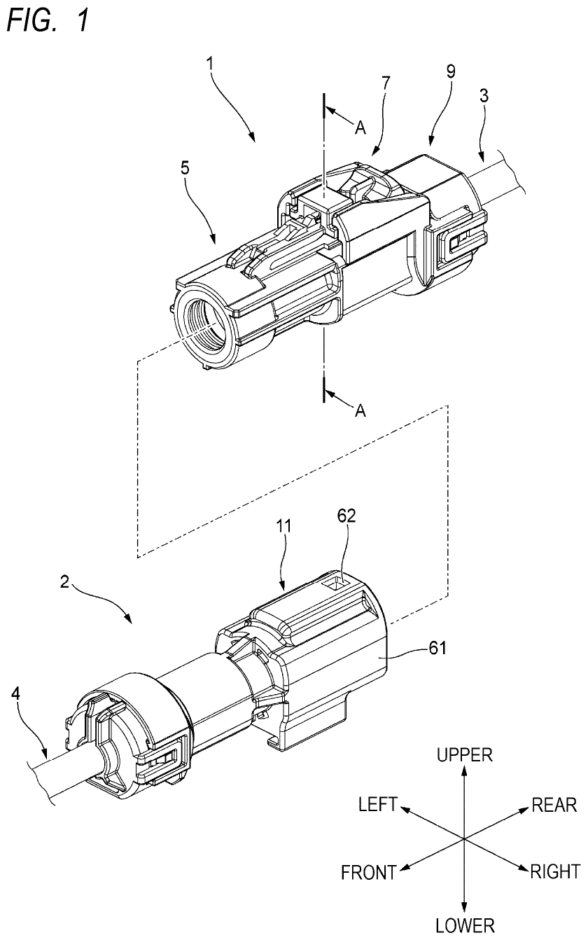

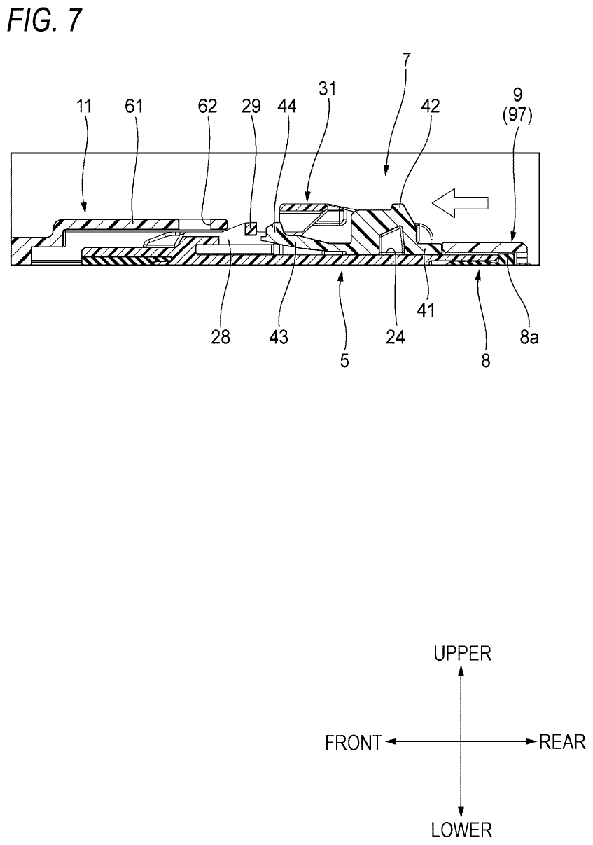

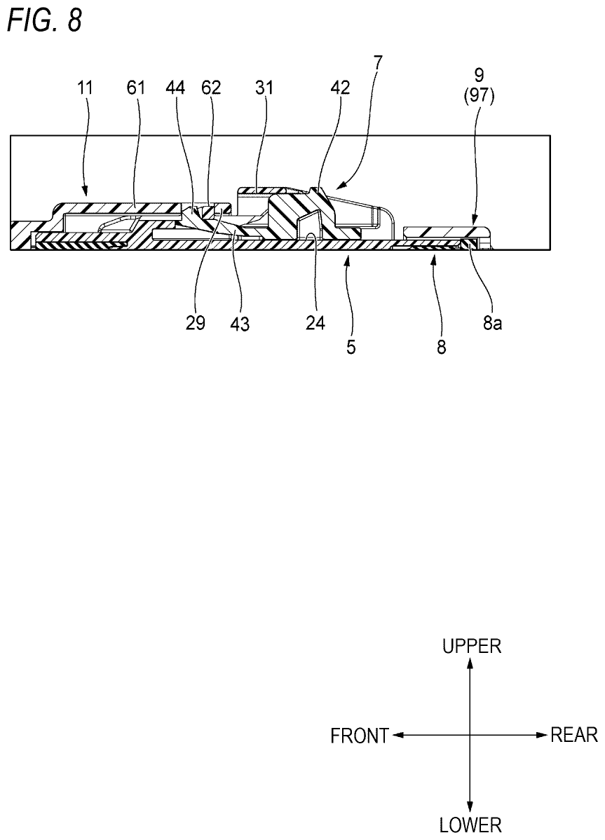

Hereinafter, a connector 1 according to an embodiment of the present disclosure will be described with reference to the drawings. The connector 1 (see FIG. 1) is a female connector connected to an electric wire 3. A counterpart connector 2 (see FIG. 1) is a male connector connected to an electric wire 4. As shown in FIGS. 7 and 8, a female housing 5 (see FIG. 1) of the connector 1 can be fitted to a male housing 11 (see FIG. 1) of the counterpart connector 2. The female housing 5 corresponds to the “housing” in the present disclosure. In the embodiment, the connector 1 is to be fitted to the counterpart connector 2, but the connector 1 may be fitted to another counterpart component (for example, a connector attachment port of a counterpart device).

Hereinafter, for convenience of description, “front”, “rear”, “left”, “right”, “upper”, and “lower” are defined as illustrated in FIG. 1 and the like. A “front-rear direction”, a “left-right direction”, and an “upper-lower direction” are orthogonal to one another. The front-rear direction coincides with a fitting direction of the connector 1 and the counterpart connector 2. For the connector 1, a front surface side in the fitting direction in which the counterpart connector 2 is fitted is referred to as a front side, and a back surface side in the fitting direction opposite thereto is referred to as a rear side.

When the female housing 5 and the male housing 11 are fitted to each other, the female housing 5 and the male housing 11 go through a state in which they are halfway fitted (see FIG. 7), and then reach a state in which the female housing 5 and the male housing 11 are completely fitted with each other (see FIG. 8). Hereinafter, for convenience of description, the former state is referred to as the “unfitted state”, and the latter state is referred to as the “fitted state”.

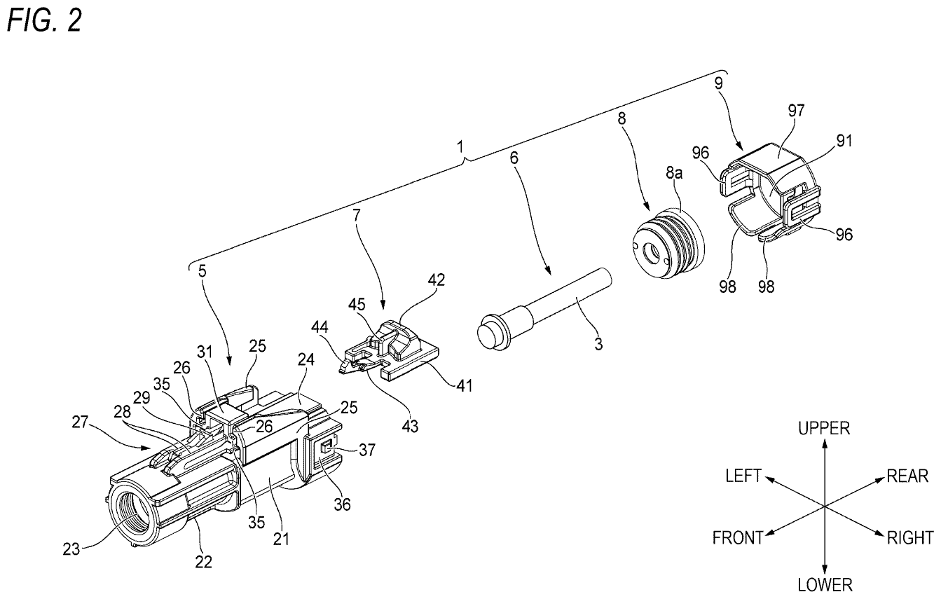

First, the connector 1 will be described with reference to FIGS. 1 to 6. As shown in FIG. 2, the connector 1 includes the female housing 5, a terminal module 6 accommodated in the female housing 5, a fitting assurance component 7 provided to be movable in the front-rear direction on an upper portion of the female housing 5, a packing 8 closing a gap between the female housing 5 and the electric wire 3 extending from the terminal module 6, and a cover 9 provided on the female housing 5 to cover a rear end surface of the packing 8. Hereinafter, configuration of each component that forms the connector 1 will be described below in order. In the following description, the “fitting assurance component” is abbreviated as “CPA”.

First, the female housing 5 will be described. As shown in FIG. 2, the female housing 5 made of resin integrally includes a rectangular tubular portion 21 having a substantially rectangular tubular shape and a cylindrical portion 22 having a substantially cylindrical shape and located in front of the rectangular tubular portion 21, and has a shape extending in the front-rear direction. The cylindrical portion 22 of the female housing 5 is inserted into a fitting recessed portion defined inside a hood portion 61 (see FIG. 1) of the male housing 11 of the counterpart connector 2, so that the female housing 5 and the male housing 11 are fitted together (see FIG. 8).

As shown in FIG. 2 and the like, a terminal accommodating chamber 23 penetrating in the front-rear direction is formed inside the female housing 5 so as to extend in the front-rear direction. The terminal module 6 is accommodated in the terminal accommodating chamber 23. The terminal module 6 is a female terminal having a shape extending in the front-rear direction, and the electric wire 3 is connected to a rear end portion of the terminal module 6 so as to extend rearward. When the female housing 5 and the male housing 11 are fitted to each other, a male terminal (not shown) accommodated in the male housing 11 and connected to the electric wire 4 (see FIG. 1) is inserted into a front end portion of the terminal accommodating chamber 23.

As shown in FIG. 2, on both left and right end portions of an upper wall 24 of the female housing 5 (more specifically, the rectangular tubular portion 21), a pair of ribs 25 rising upward are integrally provided so as to extend in a front region of the rectangular tubular portion 21 and to face each other in the left-right direction. A space between by the pair of ribs 25 functions as a space (so-called slide space) for accommodating the CPA 7 and guiding the CPA 7 in the front-rear direction. The pair of ribs 25 serve to guide the CPA 7 in the front-rear direction as it moves in the front-rear direction on the upper wall 24 of the rectangular tubular portion 21. A pair of protruding portions 26 protruding inward in the left-right direction and facing each other in the left-right direction are integrally formed at upper end portions of front regions of the pair of ribs 25 (see FIG. 2).

As shown in FIG. 2, a locking mechanism 27 is provided on the upper portion of the female housing 5 (more specifically, the cylindrical portion 22). The locking mechanism 27 has a function of switching between maintaining and releasing the fitted state of the female housing 5 and the male housing 11 by engaging with a locked hole 62 (see FIG. 1) provided in an upper portion of the hood portion 61 of the male housing 11 of the counterpart connector 2.

As shown in FIG. 2, the locking mechanism 27 includes a pair of lock arms 28 extending rearward in a cantilever shape from a front end portion of an upper portion of the cylindrical portion 22 of the female housing 5 at a distance in the left-right direction. The pair of lock arms 28 are elastically deformable in the upper-lower direction, and extend to a position above a front end portion of the upper wall 24 of the rectangular tubular portion 21 of the female housing 5. The pair of lock arms 28 are integrally formed with a lock protrusion 29 that couples, in the left-right direction, intermediate portions of the lock arms 28 in the front-rear direction, and an operation portion 31 that couples tip end portions (rear end portions) of the lock arms 28 in the left-right direction.

The operation portion 31 is located above the front end portion of the upper wall of the rectangular tubular portion 21, and a dimension of the operation portion 31 in the left-right direction is smaller than a distance between the pair of protruding portions 26 in the left-right direction. Therefore, as the pair of lock arms 28 are elastically deformed in the upper-lower direction, the operation portion 31 can move in the upper-lower direction in a space between the pair of protruding portions 26 provided on the pair of ribs 25.

The locked hole 62 of the male housing 11 is engaged with the lock protrusion 29 of the locking mechanism 27, thereby maintaining the fitted state between the female housing 5 and the male housing 11 (see FIG. 8). In this fitted state, by pushing the operation portion 31 downward, the lock protrusion 29 moves downward, the engagement between the lock protrusion 29 and the locked hole 62 is released, and the female housing 5 and the male housing 11 can be separated in the front-rear direction.

A pair of protruding portions 35 protruding outward in the left-right direction are integrally formed on the tip end portions of the pair of lock arms 28 (that is, lower portions of the operation portion 31) (see FIG. 2). The pair of protruding portions 35 interfere with the pair of protruding portions 26 in the upper-lower direction when the pair of lock arms 28 are elastically deformed upward, thereby preventing the pair of lock arms 28 from being excessively deformed upward.

As shown in FIG. 2, a pair of left and right grooves 36 are formed on outer peripheral surfaces of both end portions in the left-right direction of a rear end portion of the female housing 5. The grooves 36 are recessed inward in the left-right direction and extend forward from the rear end of the female housing 5. An engagement protrusion 37 protruding outward in the left-right direction is formed on a bottom surface of each groove 36. A pair of engagement frame body portions 96 of the cover 9, which will be described later, are inserted into the pair of grooves 36.

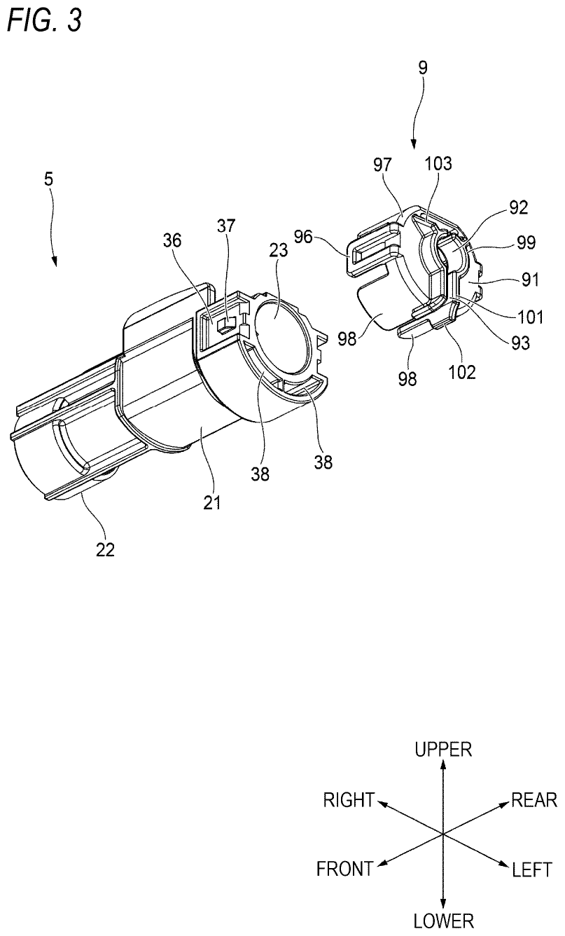

As shown in FIG. 3, a pair of left and right accommodation grooves 38 are formed in a lower region of a rear end surface of the female housing 5. The accommodation grooves 38 recess forward and extend in an arc shape along an opening edge of a rear end opening of the terminal accommodating chamber 23. A pair of left and right protruding portions 98 (see FIG. 3 and the like) to be described later of the cover 9 are accommodated in the pair of left and right accommodation grooves 38.

Next, the CPA 7 will be described. The resin CPA 7 shown in FIG. 2 is provided to be movable in the front-rear direction on the upper wall 24 of the rectangular tubular portion 21 of the female housing 5. The CPA 7 has a body portion 41 in the shape of a generally rectangular flat plate extending in the front-rear direction. A CPA operation portion 42 that protrudes upward and extends in the left-right direction is provided at an upper rear portion of the body portion 41. A dimension of the body portion 41 in the left-right direction is smaller than a distance between the pair of ribs 25 in the left-right direction. Accordingly, the body portion 41 is movable in the front-rear direction in a space between the pair of ribs 25 while being guided by the pair of ribs 25.

The body portion 41 is integrally formed with an arm portion 43 that extends forward from a central portion in the left-right direction of a front surface of the body portion 41. A protrusion 44 that engages with the lock protrusion 29 of the locking mechanism 27 is formed at a tip end portion (that is, a front end portion) of the arm portion 43 so as to protrude upward. A dimension of the arm portion 43 in the left-right direction is smaller than a dimension of the body portion 41 in the left-right direction.

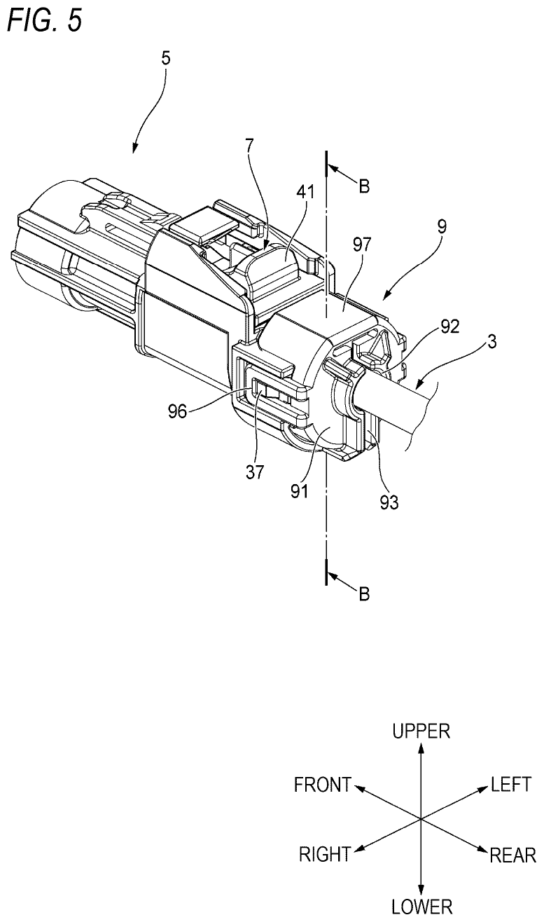

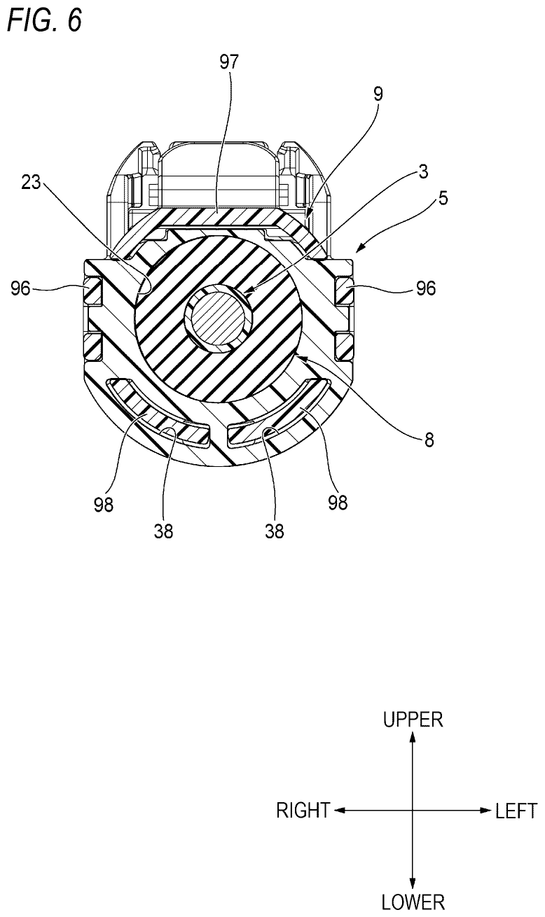

As shown in FIG. 7, in the unfitted state (the state of the connector 1 alone) before the fitting of the connector 1 and the counterpart connector 2, the CPA 7 is disposed at the initial position shown in FIG. 5 on the upper wall 24 of the rectangular tubular portion 21 of the female housing 5. Then, in the space between the pair of ribs 25 of the female housing 5, the CPA 7 is moved forward by pressing the CPA operation portion 42 forward while the CPA 7 (the body portion 41) is guided by the pair of ribs 25. Such forward movement of the CPA 7 continues until the protrusion 44 located at the tip end of the arm portion 43 of the CPA 7 engages with a rear surface of the lock protrusion 29 of the locking mechanism 27 of the female housing 5. When the protrusion 44 of the CPA 7 engages with the rear surface of the lock protrusion 29 of the female housing 5, the CPA 7 cannot move forward than the position. That is, in the unfitted state, the CPA 7 cannot be moved to the target attachment position (see FIG. 8) shown in FIG. 6.

Next, the packing 8 and the cover 9 will be described. The rubber packing 8 is a member disposed in a gap between an outer surface of the electric wire 3 extending from the terminal module 6 and an inner surface of a rear end opening of the terminal accommodating chamber 23 of the female housing 5. The packing 8 seals the gap so as to provide a waterproof function of preventing water from entering the terminal accommodating chamber 23 from the outside. As shown in FIG. 2, the packing 8 has a generally cylindrical shape extending in the front-rear direction. A rear end portion of the packing 8 has an annular flange portion 8a that protrudes radially outward. An outer peripheral shape of the packing 8 corresponds to a shape of the inner surface of the rear end opening of the terminal accommodating chamber 23, and an inner peripheral shape of the packing 8 corresponds to a shape of the outer surface of the electric wire 3.

The resin cover 9 is a member to be assembled to the rear end portion of the female housing 5 so as to cover the rear end surface of the packing 8. The cover 9 serves to prevent the packing 8 from falling off (separating) from the female housing 5 and to prevent positional deviation of the electric wire 3 extending from the terminal module 6. As shown in FIGS. 2 to 4, the cover 9 has a flat plate-shaped lid wall portion 91 disposed to close the rear end opening of the terminal accommodating chamber 23 of the female housing 5. An outer peripheral shape of the lid wall portion 91 corresponds to the shape of the rear end opening of the terminal accommodating chamber 23 of the female housing 5.

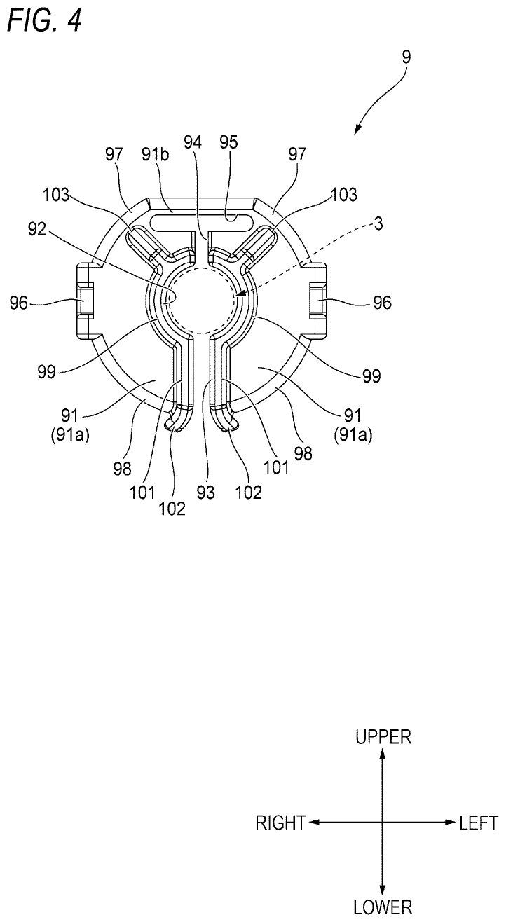

As shown in FIG. 4, a through hole 92, through which the electric wire 3 extending in the front-rear direction is inserted, is formed in a central portion of the lid wall portion 91. The lid wall portion 91 is formed with a slit 93 that communicates a lower end portion of a hole edge of the through hole 92 and a lower end portion of an outer peripheral edge of the lid wall portion 91 and extends in the upper-lower direction. A width (a distance in the left-right direction) of the slit 93 is smaller than a diameter (an outer diameter) of the electric wire 3 (see the broken line in FIG. 4). The lid wall portion 91 is further formed with a slit 94 extending upward from an upper end portion of the hole edge of the through hole 92 and a slit 95 extending from an upper end portion of the slit 94 to both left and right sides. A width (a distance in the left-right direction) of the slit 94 is also smaller than the outer diameter of the electric wire 3 (see the broken line in FIG. 4).

By forming the slit 94 and the slit 95, a portion in the vicinity of the slit 95 in the lid wall portion 91 (that is, a region in the vicinity of an upper end of the lid wall portion 91) functions as a coupling portion 91b that can be deformed into a hinge shape and couples a pair of left and right lower regions 91a of the lid wall portion 91 that sandwich the slit 93 so that the pair of left and right lower regions 91a can be displaced to increase the width of the slit 93. Thus, when the electric wire 3 is inserted into the through hole 92 through the slit 93, the width of the slit 93 can be easily increased.

As shown in FIGS. 2 and 3, the pair of left and right engagement frame body portions 96 are integrally formed on both end portions in the left-right direction of the lid wall portion 91 so as to protrude forward. Each engagement frame body portion 96 is elastically deformable in the left-right direction. Peripheral walls 97 are integrally formed on outer peripheral edges of the lid wall portion 91 located above the pair of engagement frame body portions 96 so as to protrude forward and extend along the outer peripheral edges of the lid wall portion 91. The pair of left and right outer peripheral edges of the lid wall portion 91 located between the pair of engagement frame body portions 96 and the slit 93 are integrally formed with the pair of left and right protruding portions 98 that protrude forward and extend in an arc shape along the outer peripheral edges of the lid wall portion 91 in correspondence with the pair of left and right accommodation grooves 38 (see FIG. 3) of the female housing 5.

As shown in FIGS. 3 and 4, the lid wall portion 91 is formed with a pair of left and right ribs 99 that extend along the hole edge of the through hole 92 and protrude rearward, a pair of left and right ribs 101 that extend downward from lower end portions of the pair of left and right ribs 99 along both side edges of the slit 93 and protrude rearward, a pair of left and right tapered ribs 102 that are continuous from lower end portions of the pair of left and right ribs 101 and extend obliquely downward and outward in the left-right direction, and a pair of left and right ribs 103 that extend outward in a radial direction of the through hole 92 from upper portions of the pair of left and right ribs 99 and protrude rearward. By forming the ribs 99, it is possible to prevent the occurrence of damage to an outer peripheral surface of the electric wire 3 when the outer peripheral surface of the electric wire 3 inserted into the through hole 92 comes into contact with the hole edge of the through hole 92. By forming the ribs 101, it is possible to prevent the occurrence of damage to the outer peripheral surface of the electric wire 3 when the electric wire 3 is inserted into the through hole 92 through the slit 93. By forming the tapered ribs 102, the electric wire 3 is easily guided to the slit 93 when the electric wire 3 is inserted into the through hole 92 through the slit 93. The ribs 103 serve to reinforce the ribs 99.

The packing 8 and the cover 9 are assembled to the female housing 5 as follows. First, one end portion of the electric wire 3 is inserted into the through hole 92 of the cover 9 and the through hole of the packing 8. As described above, with respect to the cover 9, one end portion of the electric wire 3 can be inserted through the through hole 92 of the cover 9 by inserting the one end portion of the electric wire 3 through the slit 93 up to the through hole 92. Next, the one end portion of the electric wire 3 is connected to the rear end portion of the terminal module 6. Next, the terminal module 6 to which the electric wire 3 is connected is accommodated in the terminal accommodating chamber 23 from the rear side through the rear end opening of the terminal accommodating chamber 23 of the female housing 5. Next, the packing 8 through which the electric wire 3 is inserted is disposed in the gap between the inner surface of the rear end opening of the terminal accommodating chamber 23 and the outer surface of the electric wire 3 in a state where the flange portion 8a is in contact with a rear end surface of the female housing 5 through the rear end opening of the terminal accommodating chamber 23 of the female housing 5 (see also FIGS. 7 and 8). As a result, an outer peripheral surface and an inner peripheral surface of the packing 8 are in close contact with the inner surface of the rear end opening of the terminal accommodating chamber 23 and the outer surface of the electric wire 3, respectively, so that the above-described waterproof function of the packing 8 is achieved (see also FIG. 6).

Next, the cover 9 through which the electric wire 3 is inserted is attached to the rear end portion of the female housing 5. In the state where the cover 9 is completely attached to the rear end portion of the female housing 5, the pair of engagement frame body portions 96 of the cover 9 are inserted into the pair of grooves 36 of the female housing 5, hole edges at a front end portion of the pair of engagement frame body portions 96 are engaged with the pair of engagement protrusions 37, the peripheral walls 97 of the cover 9 cover the rear end portion of the upper wall 24 of the female housing 5, and the pair of left and right protruding portions 98 of the cover 9 are accommodated in the pair of left and right accommodation grooves 38 of the female housing 5. The engagement between the hole edges of the pair of engagement frame body portions 96 and the pair of engagement protrusions 37 prevents the cover 9 (and further the packing 8) from falling off (separating) from the female housing 5. Further, in the embodiment, since the peripheral wall 97 of the cover 9 is disposed to cover a rear end portion of the upper wall 24 of the female housing 5 (see FIGS. 1 and 7), the CPA 7 disposed on the upper wall 24 of the female housing 5 is prevented from moving (falling off) backward (see FIG. 7).

Further, even if an external force in a direction intersecting an axial direction of the electric wire 3 is applied to the electric wire 3 extending to the outside of the female housing 5 through the through hole 92 of the cover 9, the positional deviation of the electric wire 3 is prevented by a hole wall of the through hole 92. In particular, when a downward external force is applied to the electric wire 3, the electric wire 3 tries to move from the through hole 92 to the slit 93. However, since the width of the slit 93 is smaller than the outer diameter of the electric wire 3, the electric wire 3 cannot move from the through hole 92 to the slit 93 and remains in the through hole 92, thereby preventing the positional deviation of the electric wire 3. Similarly, when an upward external force is applied to the electric wire 3, the electric wire 3 tries to move from the through hole 92 to the slit 94. However, since the width of the slit 94 is smaller than the outer diameter of the electric wire 3, the electric wire 3 cannot move from the through hole 92 to the slit 94 and remains in the through hole 92, thereby preventing the positional deviation of the electric wire 3.

Further, since the pair of left and right protruding portions 98 which are curved in an arc shape of the cover 9 are accommodated in the pair of left and right accommodation grooves 38 which are curved in an arc shape of the female housing 5, even if an external force is applied to the electric wire 3 in the left-right direction, the curved protruding portions 98 come into contact with groove inner surfaces of the curved accommodation grooves 38, so that deformation that may increase the width of the slit 93 of the cover 9 (that is, the electric wire 3 easily moves from the through hole 92 to the slit 93) can be prevented. As described above, the deformation of the packing 8 caused by the positional deviation of the electric wire 3 is prevented, so that deterioration in the waterproof function of the packing 8 caused by the deformation of the packing 8 is reduced. The connector 1 has been described above.

Hereinafter, an operation of fitting the connector 1 to the counterpart connector 2 will be described. As shown in FIGS. 7 and 8, the connector 1 connected to the electric wire 3 and having the CPA 7 locked at the initial position is fitted to the counterpart connector 2. The fitting operation is performed such that the cylindrical portion 22 of the female housing 5 is inserted into the fitting recessed portion in the hood portion 61 of the male housing 11, and the terminal module 6 (female terminal) accommodated in the female housing 5 and connected to the electric wire 3 is connected to the male terminal accommodated in the male housing 11 and connected to the electric wire 4. The fitting operation is continued until the locked hole 62 of the male housing 11 engages with the lock protrusion 29 of the locking mechanism 27 of the female housing 5.

A hole edge of the locked hole 62 passes over an upper portion of the lock protrusion 29 of the locking mechanism 27 that is temporarily elastically deformed downward due to the pressure from the hole edge of the locked hole 62, and moves to the rear side of the lock protrusion 29 of the locking mechanism 27 that has elastically returned, so that the locked hole 62 and the lock protrusion 29 are engaged with each other (see FIG. 8). Thus, the female housing 5 and the male housing 11 are maintained in the fitted state.

Further, when the hole edge of the locked hole 62 moves to the rear side of the lock protrusion 29, the protrusion 44 of the CPA 7 positioned at the rear side of the lock protrusion 29 is pushed down by the hole edge of the locked hole 62, so that the arm portion 43 of the CPA 7 is elastically deformed downward, and the engagement between the protrusion 44 and the lock protrusion 29 is released. That is, the CPA 7 can move to the target attachment position in the front (see FIG. 6). In this state, the CPA 7 (CPA operation portion 42) is pushed forward, so that the CPA 7 moves to the target attachment position shown in FIG. 8 while the arm portion 43 is kept elastically deformed downward. When the CPA 7 reaches the target attachment position, the protrusion 44 passes over a lower portion of the lock protrusion 29 and the arm portion 43 elastically returns, so that the protrusion 44 moves to the front side of the lock protrusion 29. Thus, the CPA 7 is locked to the target attachment position.

When the CPA 7 is at the target attachment position, the CPA 7 serves to ensure that the female housing 5 and the male housing 11 are in the fitted state. Further, in a state in which the CPA 7 is at the target attachment position, as shown in FIG. 8, the protruding portion 45 of the CPA 7 is in contact with the operation portion 31 of the locking mechanism 27, so that the operation portion 31 cannot move downward. This prevents the operation portion 31 from unintentionally moving downward and reducing an engagement allowance between the lock protrusion 29 and the locked hole 62. That is, a decrease in the engagement force is prevented. Thus, the CPA 7 also serves to prevent the release of the engagement between the lock protrusion 29 and the locked hole 62 caused by the downward elastic deformation of the locking mechanism 27 (so-called double locking function).

On the other hand, when the female housing 5 and the male housing 11 are in the unfitted state, the hole edge of the locked hole 62 of the male housing 11 does not push the protrusion 44 of the CPA 7 downward, so that the engagement between the protrusion 44 and the lock protrusion 29 is not released. Therefore, the CPA 7 cannot move from the initial position to the target attachment position. In this way, since the CPA 7 cannot move from the initial position to the target attachment position, the unfitted state between the female housing 5 and the male housing 11 can be easily detected. The operation of fitting the connector 1 to the counterpart connector 2 has been described above.

In the fitted state of the female housing 5 and the male housing 11, the terminal module 6 accommodated in the female housing 5 and the male terminal accommodated in the male housing 11 are electrically connected. Thus, the electric wire 3 connected to the terminal module 6 and extending from the female housing 5 and the electric wire 4 connected to the male terminal and extending from the male housing 11 are electrically connected.

Next, an operation for separating the female housing 5 and the male housing 11 from a state shown in FIG. 8 (a state where the female housing 5 and the male housing 11 are in the fitted state and the CPA 7 is at the target attachment position) for maintenance or the like will be described.

In order to separate the female housing 5 and the male housing 11, first, the CPA 7 is returned from the target attachment position to the initial position by pulling the CPA operation portion 42 of the CPA 7 backward. Next, the operation portion 31 of the locking mechanism 27 is pushed downward into the space between the pair of ribs 25. Thus, the lock protrusion 29 of the locking mechanism 27 elastically deformed downward moves downward. As a result, the engagement between the lock protrusion 29 and the locked hole 62 is released, and the female housing 5 and the male housing 11 can be separated in the front-rear direction. Therefore, the female housing 5 and the male housing 11 can be separated from each other.

### Operations and Effects

As described above, according to the connector 1 of the present embodiment, the cover 9 attached to the female housing 5 prevents the packing 8 from being displaced toward the outer side by the lid wall portion 91 of the cover 9. Further, when the cover 9 is attached to the female housing 5 in a state where the electric wire 3 is inserted into the through hole 92 of the cover 9, the width of the slit 93 is smaller than the diameter of the electric wire 3. Accordingly, even if an external force is applied to the electric wire 3 in any direction intersecting the axial direction of the electric wire 3, the positional deviation of the electric wire 3 is prevented by the hole wall of the through hole 92. Therefore, the connector 1 according to the present embodiment can prevent the positional deviation of the electric wire 3 as compared to a connector in the related art.

Further, the cover 9 is configured such that the coupling portion 91b that couples the pair of left and right lower regions 91a can be deformed into a hinge shape so that the pair of left and right lower regions 91a sandwiching the slit 93 can be displaced to increase the width of the slit 93. Thus, when the electric wire 3 is inserted into the through hole 92 through the slit 93, the width of the slit 93 can be easily increased, so that workability of attaching the cover 9 to the electric wire 3 can be improved.

Further, the curved left and right protruding portions 98 of the cover 9 are accommodated in the pair of left and right accommodation grooves 38 of the female housing 5. Accordingly, even if an external force is applied to the electric wire 3 in any direction intersecting the axial direction of the electric wire 3, the curved protruding portions 98 come into contact with the groove inner surfaces of the curved accommodation grooves 38, so that deformation that may increase the width of the slit 93 of the cover 9 can be prevented.

### Other Embodiments

The present disclosure is not limited to the embodiment described above and various modifications can be adopted within the scope of the present disclosure. For example, the disclosure is not limited to the embodiment described above, and modifications, improvements, and the like can be made appropriately. In addition, materials, shapes, sizes, numbers, arrangement positions, or the like of components in the above-described embodiment are freely selected and are not limited as long as the present disclosure can be implemented.

Here, features of the embodiment of the connector 1 according to the present disclosure described above are briefly summarized and listed in the following [1] to [3].

[1]A connector (1) including:
a housing (5) having a terminal accommodating chamber (23) therein;
an electric wire (3) drawn out to an outside through an opening connected to the terminal accommodating chamber (23) of the housing (5);
a water stop component (8) disposed to close a gap between an inner surface of the opening and an outer surface of the electric wire (3); and
a cover (9) attached to the housing (5) on an outer side of the water stop component (8),
in which the cover (9) has
a restriction portion (91) disposed to face the water stop component (8) and configured to restrict displacement of the water stop component (8) to the outer side,
a through hole (92) provided in the restriction portion (91) and through which the electric wire (3) is inserted, and
a slit (93) extending in a predetermined direction from a hole edge of the through hole (92) and communicating with the outside of a peripheral edge of the restriction portion (91), and
in which when the cover (9) is attached to the housing (5), a width of the slit (93) is smaller than a diameter of the electric wire (3).

According to the connector having the configuration of the above [1], the cover attached to the housing is provided with the slit through which the electric wire passes when attaching the cover to the electric wire and the through hole through which the electric wire attached through the slit is inserted. Further, when the cover is attached to the housing, the width of the slit is smaller than the diameter of the electric wire. Accordingly, even if an external force is applied to the electric wire in any direction intersecting the axial direction of the electric wire in a state where the cover is attached to the housing, the displacement of the electric wire is prevented by the hole wall of the through hole. In particular, even when the electric wire tries to move in a direction in which the electric wire enters the slit, the width of the slit is smaller than the diameter of the electric wire, so that the electric wire does not enter the slit. Therefore, the connector of the present configuration can prevent displacement of the electric wire.

[2] In the connector (1) according to the above [1],
the cover (9) has a coupling portion (91b) that couples one side portion (91a) and the other side portion (91a) of the cover (9) that sandwich the slit (93), and
the coupling portion (91b) is deformable into a hinge shape such that the one side portion (91a) and the other side portion (91a) are displaced to increase the width of the slit (93).

According to the connector having the configuration of [2], the coupling portion coupling the one side portion and the other side portion can be deformed into a hinge shape so that the one side portion and the other side portion that sandwich the slit can be displaced to increase the width of the slit. Thus, when the electric wire is inserted into the through hole through the slit, the width of the slit can be easily increased, so that workability of attaching the cover to the electric wire can be improved.

[3] In the connector (1) according to the above [2],
the cover (9) has a protruding portion (98) protruding toward the housing (5) and curved to surround the electric wire (3),
the housing (5) has an accommodation groove (38) curved to receive the protruding portion (98), and
when the cover (9) is attached to the housing (5), the protruding portion (98) is inserted into the accommodation groove (38).

According to the connector having the configuration of the above [3], the curved protruding portion of the cover is accommodated in the curved accommodation groove of the housing. Accordingly, even if an external force is applied to the electric wire in any direction intersecting the axial direction of the electric wire, the curved protruding portion come into contact with the groove inner surface of the curved accommodation groove, so that deformation that may increase the width of the slit of the cover can be prevented.

1. A connector comprising:
a housing having a terminal accommodating chamber therein;
an electric wire drawn out to an outside through an opening connected to the terminal accommodating chamber of the housing;
a water stop component disposed to close a gap between an inner surface of the opening and an outer surface of the electric wire; and
a cover attached to the housing on an outer side of the water stop component,
wherein the cover includes:
a restriction portion disposed to face the water stop component and configured to restrict displacement of the water stop component to the outer side;
a through hole provided in the restriction portion and through which the electric wire is inserted; and
a slit extending in a predetermined direction from a hole edge of the through hole and communicating with the outside of a peripheral edge of the restriction portion, and
wherein when the cover is attached to the housing, a width of the slit is smaller than a diameter of the electric wire.

2. The connector according to claim 1,
wherein the cover has a coupling portion that couples one side portion and the other side portion of the cover that sandwich the slit, and
wherein the coupling portion is deformable into a hinge shape such that the one side portion and the other side portion are displaced to increase the width of the slit.

3. The connector according to claim 2,
wherein the cover has a protruding portion protruding toward the housing and curved to surround the electric wire,
wherein the housing has an accommodation groove curved to receive the protruding portion, and
wherein when the cover is attached to the housing, the protruding portion is inserted into the accommodation groove.
